(19) United States
(12) Patent Application Publication
(10) Pub. No.: US 2024/0223682 A1
(43) Pub. Date: Jul. 4, 2024

(54) Stickiness Removal for Stateful Application

(71) Applicant: Parallel Wireless, Inc., Nashua, NH (US)

(72) Inventors: Mukesh Singhal, Pune (IN); Lalit Talele, Pune (IN)

(21) Appl. No.: 18/536,226

(22) Filed: Dec. 11, 2023

Related U.S. Application Data
(60) Provisional application No. 63/431,465, filed on Dec. 9, 2022.

(51) Int. Cl. H04L 69/18; H04L 67/142

(52) U.S. Cl. CPC H04L 69/18; H04L 67/142

(57) ABSTRACT

A method is disclosed, comprising: determining, at an application pod, Responsibility of allocation/deallocation of individual protocol identifier; receiving, at a centralized identifier Range allocator, a request from the application pod, the request including an address of the application pod; assigning, at the centralized identifier range allocator, a new range in response to the received request; sending, from the centralized identifier range allocator to a database, and responding, from the centralized identifier range allocator to the application pod, the new identifier range.

### CROSS-REFERENCE TO RELATED APPLICATIONS

The present application claims priority under 35 U.S.C. § 119(e) to U.S. Provisional Patent App. No. 63/431,465, titled “Stickiness Removal for Stateful Application” and filed Dec. 9, 2022, which is also incorporated by reference in its entirety for all purposes. The present applications are also incorporated by reference in their entirety for all purposes: U.S. Pat. App. Pub. Nos. US20230370872A1; US20230269633A1.

### BACKGROUND

Public and private cloud infrastructure is built primarily for stateless applications. Some of the transport protocols are stateful (SCTP) and some are stateless (HTTP). Stateful applications has some stickiness related to transaction/session handling. Due to stickiness of stateful application, it may not be able to utilize lot of features provided by cloud infrastructure.

Web applications uses HTTP/TCP as transport protocol. HTTP protocol is stateless. Sessions on top of HTTP can be made stateless with the help of database. Statelessness of HTTP is completely suitable for cloud deployments, and it can utilize all the features of cloud infrastructure.

While there are protocols which are inherently stateful, cost of making stateless can be very high as this may require recreation & destruction of protocol state in multiple layers. This can even be error prone if protocol stack code is third party or open source.

### BRIEF DESCRIPTION OF THE DRAWINGS

FIG. 1 is a schematic drawing of a CU-CP/CU-UP OpenRAN architecture, in accordance with some embodiments.

FIG. 2 is a schematic drawing of a CU-CP internal logical architecture, in accordance with some embodiments.

FIG. 3 is a schematic drawing of an ID range allocator, in accordance with some embodiments.

FIG. 4 is a schematic drawing of a containerized architecture with internal discovery, in accordance with some embodiments.

FIG. 5 is a schematic drawing of an F1 microservice interacting with a UE management microservice, in accordance with some embodiments.

FIG. 6 is a schematic drawing of an ID range allocation table, in accordance with some embodiments.

FIG. 7 is a schematic drawing of a UE management microservice interacting with an ID range allocation table, in accordance with some embodiments.

FIG. 8 is a schematic drawing of an F1 microservice interacting with an ID range allocation table, in accordance with some embodiments.

FIG. 9 is a schematic drawing of a multi-RAT RAN deployment architecture, in accordance with some embodiments.

### SUMMARY

In one embodiment, a method is disclosed, comprising: determining, at an application pod, Responsibility of allocation/deallocation of individual protocol identifier; receiving, at a centralized identifier Range allocator, a request from the application pod, the request including an address of the application pod; assigning, at the centralized identifier range allocator, a new range in response to the received request; sending, from the centralized identifier range allocator to a database, and responding, from the centralized identifier range allocator to the application pod, the new identifier range.

### DETAILED DESCRIPTION

Any of the following components could be used with the present disclosure, in some embodiments.

CU-CP: This node handles RRC and the control plane part of the PDCP protocol. This node communicates with DU over F1-C interface and with CU-UP over E1 interface as defined in 3GPP specifications.

CU-UP/s: This node handles user plane part of PDCP protocol and SDAP protocol. It communicates with CU-CP over E1 interface and with DU over F1-U interface.

SMO (Service management and orchestration). SMO is responsible for orchestration and management of gNB-CU-UP, gNB-CU-CP & DU node. Control of infra structure component like CPU/Memory and scale up and scale down operations. FCAPS (Fault, Configuration, Security, Performance, Accounting) management of Open-RAN elements (gNB-CU-CP, gNB-CU-UP, gNB-DU).

AMF/SMF: 3GPP defined 5G core network element for control signaling.

UPF: 3GPP defined 5G core network element for data-plane traffic.

DU (gNB-DU): 3GPP defined 5G access network element.

E1-Micro-service: Internal Micro-service in CU-UP cluster to handle SCTP+E1-APP interface signaling with gNB-CU-CP. E1-APP & SCTP connections terminates at E1-micro-service. This micro-service can have multiple E1 PODs to handle high signaling load.

NGAP-Micro-service: Internal Micro-service in CU-CP cluster to handle SCTP+NGAP-APP interface signaling with AMF. NGAP-APP & SCTP connections terminates at NGAP-micro-service. This micro-service can have multiple PODs to handle high signaling load.

F1-App/F1-Micro-service: Internal Micro-service in CU-CP cluster to handle SCTP+F1-App/F1-APP interface signaling with DU. F1-App/F1-APP & SCTP connections terminates at F1-App/F1-micro-service. This micro-service can have multiple PODs to handle high signaling load.

Xn/X2-Micro-service: Internal Micro-service in CU-CP cluster to handle SCTP+Xn/X2-APP interface signaling with 5G/4G-CU. Xn/X2-APP & SCTP connections terminate at Xn/X2-micro-service.

Internal Controller: It keeps track of health of all PODs & micro services in a given namespace. As soon as any pod/container crashes, it updates the remaining pods. And takes necessary steps to bring system in workable state.

The goal is to utilize this cloud infrastructure and its features in products and services. This can be enhanced by removing the stickiness of sessions or transaction in cloud infrastructure. In stateful application, Stickiness means, session/transaction served by specific instance of applications has to be served by same application/task/pod instance.

The problem is that Since there is stateful behaviour required by the protocols in gNB-CU-CP, as state is also maintained by peer nodes & end subscribers, depending on protocol termination points. Stickiness of session/transaction can pose some limitations in high availability, scale down, software upgrades etc.

Solution to Problem: With the help of “Centralized ID Range allocator”, Internal function discovery and in-memory database, The stickyness of stateful application can be removed. Sessions and transaction can be reassigned to any other instance of application available at any given time.

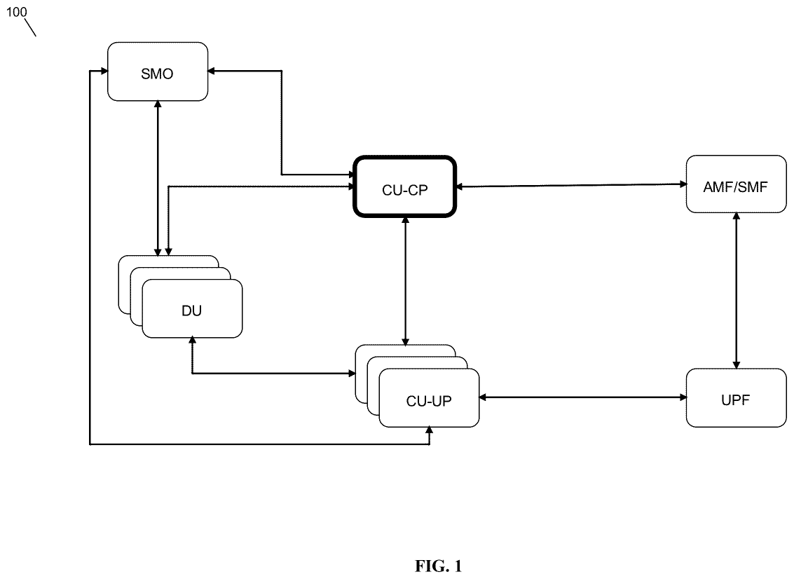

FIG. 1 is a schematic drawing of a CU-CP/CU-UP OpenRAN architecture, in accordance with some embodiments. Following diagram depict logical architecture of gNB-CU-CP. There are multiple micro-services and pods in single gNB-CU-CP. Depending on deployment requirement most of the micro-service can utilize multiple PODs for scaling purposes. The central unit (CU) is divided up into the CU-CP (control plane) and CU-UP (user plane), and provides support for the higher layers of the protocol stack such as SDAP, PDCP and RRC. Sometimes multiple CU-UPs are needed to provide support for a large number of users. The CU-CP and CU-UP are in communication with a plurality of distributed units (DUs). A SMO (service management and orchestration) is present in the core network as well. Mobility is provided by the AMF/SMF (access management function/session management function). The 5G User Plane Function (UPF) is the function that does all of the work to connect the actual data coming over the Radio Area Network (RAN) to the Internet. OpenRAN architecture splits the CU-UP, the CU-CP, and the DU from each other. Not shown are near real-time RIC (RAN intelligent controller) and non-real-time RIC.

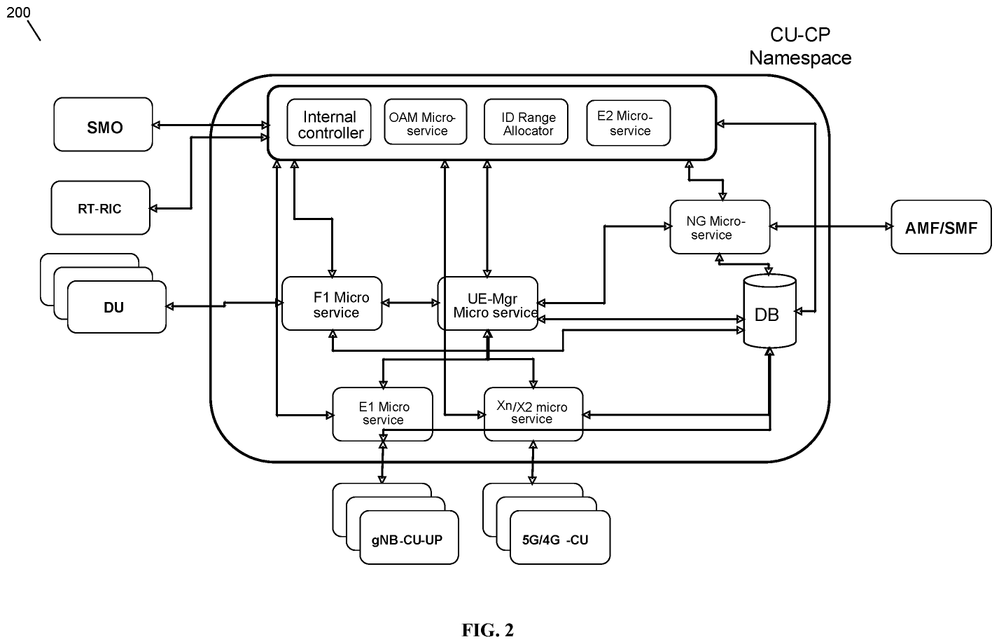

FIG. 2 is a schematic drawing of a CU-CP internal logical architecture, in accordance with some embodiments. In the CU-CP namespace are a number of microservices, including an internal controller and associated microservices (OAM microservice, E2 microservice), which is also where the ID range allocator microservice is located, in some embodiments; as well, there are other microservices, such as the F1 microservice, the UE manager (UE controller) microservice, Xn/X2 microservice, E1 microservice, NGAP microservice, etc. A database is shared by the microservices. The database uses techniques and technologies for high reliability and high availability, and is provisioned for high throughput and low latency, in particular being an in-memory database, in some embodiments, and in some embodiments providing sharding, shared memory, concurrent access, etc. The database presents a database interface to each of the microservices within the CU-CP namespace, in some embodiments. External to the CU-CP namespace are the SMO, RT-RIC, DU (times n), gNB-CU-UP (times n), 5G or 4G CU (times n), AMF/SMF as appropriate. In some embodiments the microservices are implemented using container architecture. Being within the same namespace, in some embodiments, may also indicate being on the same hardware or within the same local network, as well as sharing a namespace, in some embodiments.

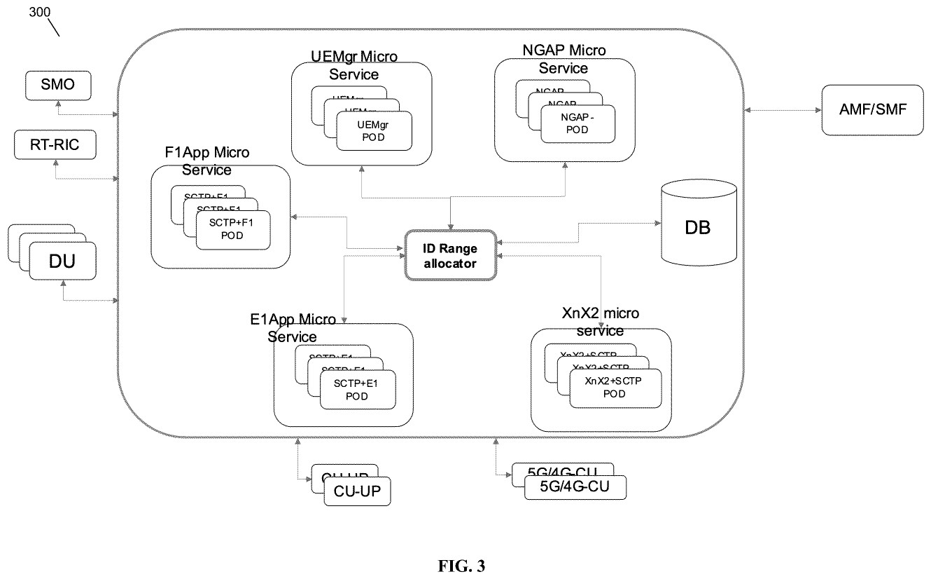

FIG. 3 is a schematic drawing of an ID range allocator architecture, in accordance with some embodiments. The same microservices described above with relation to FIG. 2 are shown in FIG. 3, along with multiple pods (containers) within each microservice to show that each microservice also includes its own load sharing, redundancy, sharding, redundancy, resiliency etc. using a container mechanism. Each container is understood to communicate via IP with the other microservices. Each container also has IP connectivity to the ID range allocator. While in some embodiments multiple pods may be required for performing the ID range allocation, in most cases a single pod is sufficient given that it is only performing ID allocation, and given that each allocation request allocates a large number of IDs at a time, for example 1,000 or 5,000. The ID range allocator service can itself be split over multiple pods (the term pod is used interchangeably herein with containers), with the split being performed by enabling each ID range allocator service to provide allocation service over a certain subset of a total ID range space (which is unlimited).

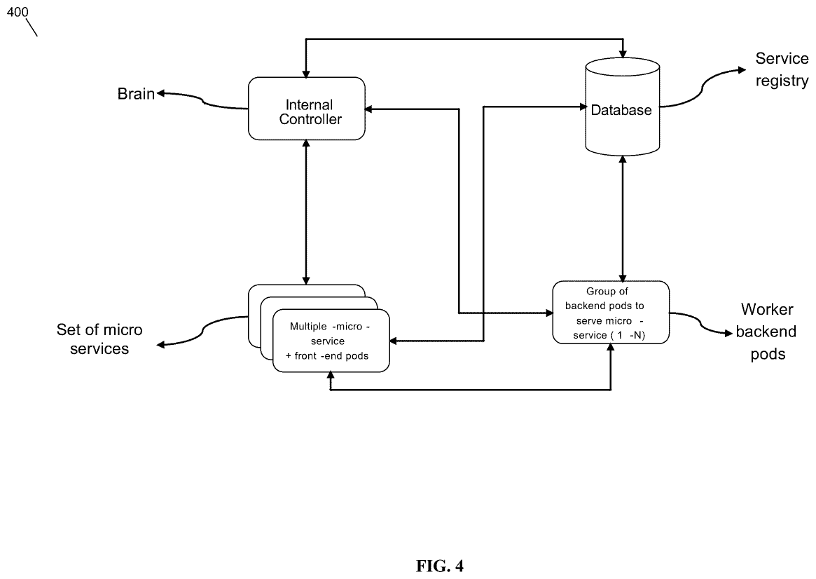

FIG. 4 is a schematic drawing of a containerized architecture with an internal service discovery framework, in accordance with some embodiments. Internal controller will keep track of internal changes in given namespace/cluster.

Internal controller: It keeps track of health of all PODs & micro services in a given namespace. As soon as any pod/container crashes, it updates the remaining pods. And takes necessary steps to bring system in workable state.

Database (Service registry): This database act as service registry database for all pods and micro-service in given namespace. All the pods on start-up can update required information in database & fetch required information from service registry database.

Data-plane POD crash and high availability. If any of the Data-Plane pod crashes, internal controller would identify based on liveliness probes or heart-beat missing events.

Internal controller would initiate procedure to make passive/standby POD to active state. Internal controller would inform credential of the Data-plane pod to passive POD.

Passive/standby POD already maintain all the flows of all active PODs in it as backup. Passive POD would identify the flows of the impacted data-plane POD and mark those flows to active state. Mark remaining non-active flows passive/standby POD to be removed.

Internal controller will trigger label change of this passive/standby data-plane POD; Migrate Data-plane IP of crashed POD to this passive/standby data-plane POD; and SMO will launch new standby/passive POD for backup. Label change may be done using POD configuration mechanisms such as Kubernetes, in some embodiments.

Internal controller is aware of all services running on the failed data plane POD and keeps the standby up to date with the same set of services and with configurations of those services, in some embodiments, which may utilize the service registry to track this functionality, in some embodiments. When the failover occurs, depending on whether orderly shutdown occurs on the failed POD, up to date state may or may not be able to be synced. Failover may involve identifying and marking flows of certain impacted data flows, in some embodiments. In some embodiments, flows that are not active may be marked for removal. A single standby DP can be used, in some embodiments, or an active-active standby, or a set of multiple standbys, in some embodiments.

When a container or microservice fails, failover involves notifying, from the controller to the ID range allocator, details regarding which pod has failed. Based on this information, the ID range served by the failed pod can be redistributed to other pods. The other pods may be hot standby pods, which maintain a recent copy of a certain set of sessions active at any time, in some embodiments. Or, the other pods may be regular active pods, which may have incomplete state when the failover occurs and may then connect to the other node (e.g., UE, AMF, etc.) to update with any necessary current state, in some embodiments. At any one time only one pod is allocated with a single ID, with no duplicates, and this is managed by the ID range allocator, in some embodiments. This ensures that all transactions are not hampered by additional lookups before being connected directly to the relevant microservice/container.

As shown in above diagram, Any application pod can request Central ID range allocator “ID range” required to serve transaction and sessions. In above diagram, multiple micro services and each microservices has multiple application POD to serve peer nodes. Each micro service is scalable independently.

Whenever needed, Application PODs can request to “ID Range allocator Micro-service/POD” for allocation of ID range for specific protocol or internal use. Central ID allocator assign new ID range, update the database & sends response to Application POD with new ID range. Each application POD can request as many ID range as required based on requirement any time. Responsibility of allocation/deallocation of individual protocol-ID will be with Application POD only. Whenever any application POD goes down, ID Range allocator will receives death notification of any PODs via “Internal Controller” in given name-space. Based on the instruction received from internal controller and information available at Central ID allocator. ID range being served by specific Application POD can be re-distributed to standby/hot-standby POD or to remaining active POD based on application requirements. This transition can be very fast. All the required information related to died application POD is already available in database. On Crash, any new or other existing POD/container can own sessions of crashed POD, providing efficient high availability

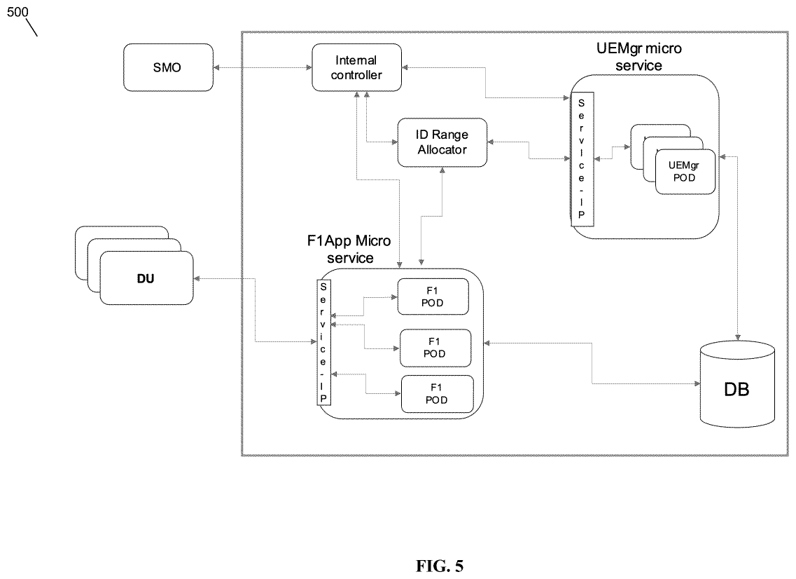

FIG. 5 is a further schematic drawing of an ID range allocator architecture, in accordance with some embodiments. Both an F1 app microservice and a UE management microservice are shown, each interacting with a shared ID range allocator and a shared database. The microservices each have a single IP that is shared among the pods within that microservice. Session information may be used to assign incoming traffic to individual pods, in some embodiments, or an allocated ID may be used, in some embodiments, or a combination thereof. This thereby removes stickiness with help of Internal Controller, database and Central ID allocator.

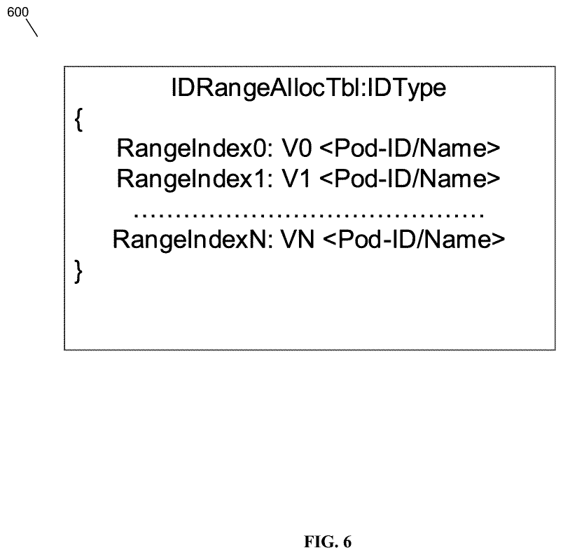

FIG. 6 is a schematic drawing of an ID range allocation table, in accordance with some embodiments. At the ID allocation table, a tuple of range index and pod ID/name is stored. If a constant range index is used, a single number that maps to the range can be used as the range index, for example, an ordinal number (here V0, V1, . . . VN), or for example, the beginning of the range. If variable range indices are used, where some ranges are larger or have longer runs than others, the beginning and end of the range can be stored. As ranges are non-overlapping, a data structure that allows for insertions and deletions can be used, or, a data structure that allows for versioning and searching can be used, or another method as is well-understood in the art. The entire data structure can be kept in memory, in some embodiments. In some embodiments an in-memory database may be used. No duplicate ID allocation across multiple container/POD instance is ensured by the allocator. This also ensures there are no latency issues and reduced transaction with Database, as no need to database look-up for every transaction since each ID is held only by one pod at a time. The allocation table has minimal scalability issues, ID allocator allocates range of ID. Let's assume pre request ID range allocation is 1K in 1 message. Even if 1 million ID per seconds allocation requirement will result in 1K range/see which can be handled by single core container easily.

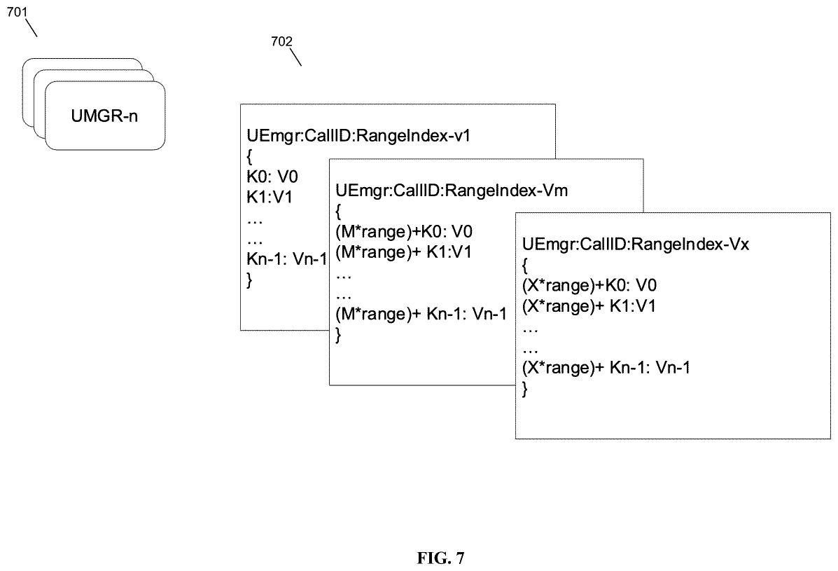

FIG. 7 is a schematic drawing of a UE management microservice interacting with an ID range allocation table, in accordance with some embodiments. The UE management microservice has multiple pods, as shown by 701. The ID ranges have been allocated by the allocator and each pod 702 maps its specific range to a specific UE manager call ID, allowing requests from particular UEs to be handled by a specific pod and all requests on that pod to be failed over when that pod fails.

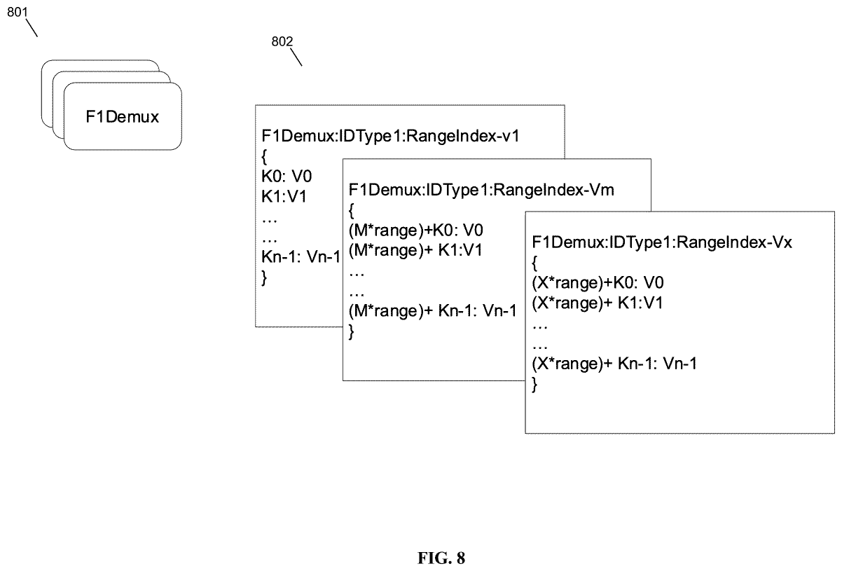

FIG. 8 is a schematic drawing of an F1 microservice interacting with an ID range allocation table, in accordance with some embodiments. The F1 management microservice has multiple pods, as shown by 801. The ID ranges have been allocated by the allocator and each pod 802 maps its specific range to a specific F1 request, allowing particular F1 requests to be handled by a specific pod and all requests on that pod to be failed over when that pod fails.

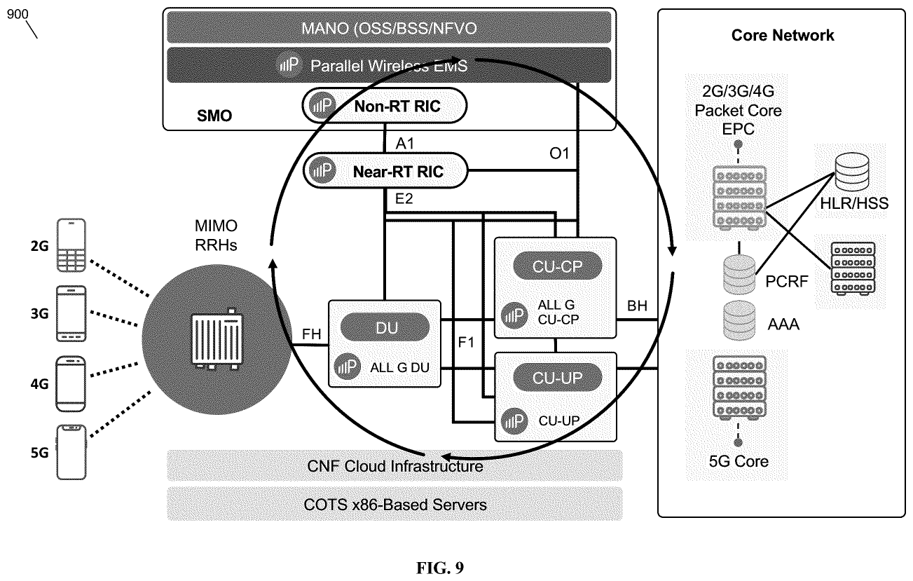

FIG. 9 is a schematic drawing of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users.

As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, to 2G networks, or to networks for additional protocols that utilize radio frequency data transmission. Various components in the devices described herein may be added, removed, split across different devices, combined onto a single device, or substituted with those having the same or similar functionality. This approach can be utilized by any cloud application as this is generic problem for stateful application, in some embodiments.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method, comprising:
determining, at an application pod, Responsibility of allocation/deallocation of individual protocol identifier;
receiving, at a centralized identifier Range allocator, a request from the application pod, the request including an address of the application pod;
assigning, at the centralized identifier range allocator, a new range in response to the received request;
sending, from the centralized identifier range allocator to a database, and
responding, from the centralized identifier range allocator to the application pod, the new identifier range.

2. The method of claim 1, further comprising an internal function discovery pod.

3. The method of claim 1, further comprising using an in-memory database.

4. The method of claim 1, further comprising an application pod requesting IDs for transactions and sessions.

5. The method of claim 1, further comprising any application pod for at least two of the following microservice types can request an ID range.

6. The method of claim 1, further comprising Requesting a new range when previously-allocated range is used up at the requestor node.

7. The method of claim 1, further comprising Death notifications, and redistributions to standby pods.

8. The method of claim 1, further comprising requesting 1000 ID range allocation in 1 message.

9. The method of claim 1, further comprising Creating new pods to handle sessions of crashed pod.

10. The method of claim 1, further comprising Dynamic changes sent to a set of pods in a given namespace.

11. The method of claim 1, further comprising SCTP.

12. The method of claim 1, further comprising enabling use in public and private clouds.

13. The method of claim 1, further comprising migrating a session to a new pod.

14. The method of claim 1, further comprising migrating a transaction to a new pod.

15. The method of claim 1, further comprising providing ID ranges for CU X2 app, DU F1 app, AMF NGAP, E1 app and gNB-CU-CP.

16. The method of claim 1, further comprising avoiding duplicate ID allocation across multiple container/POD instances.
